(19) United States
(12) Patent Application Publication
(10) Pub. No.: US 2026/0061236 A1
(43) Pub. Date: Mar. 5, 2026

(54) FIRE EXTINGUISHING PIPE, BATTERY MODULE, AND ENERGY STORAGE APPARATUS

(71) Applicant: Samsung SDI Co., Ltd., Yongin-si (KR)

(72) Inventor: Taesin Hwang, Yongin-si (KR)

(73) Assignee: Samsung SDI Co., Ltd., Yongin-si (KR)

(21) Appl. No.: 19/189,748

(22) Filed: Apr. 25, 2025

(30) Foreign Application Priority Data
Sep. 3, 2024 (KR) 10-2024-0119626

(51) Int. Cl. A62C 3/16; H01M 50/209

(52) U.S. Cl. CPC A62C 3/16; H01M 50/209

(57) ABSTRACT

Disclosed are a fire extinguishing pipe, a battery module, and an energy storage apparatus. The fire extinguishing pipe may include a fire extinguishing agent supply part configured to supply a fire extinguishing agent, a screen disposed between a plurality of battery cells and having a plurality of holes formed therein, and a pipe part connected to the fire extinguishing agent supply part and configured to have the fire extinguishing agent flow therethrough, the pipe part being configured to be partially exposed through the plurality of holes of the screen.

### CROSS-REFERENCE TO RELATED APPLICATIONS

This present application claims priority to and the benefit under 35 U.S.C. § 119(a)-(d) of Korean Patent Application No. 10-2024-0119626, filed on Sep. 3, 2024, in the Korean Intellectual Property Office, the entire disclosure of which is incorporated herein by reference.

### FIELD

The present disclosure relates to a fire extinguishing pipe, a battery module, and an energy storage apparatus, and particularly, to a fire extinguishing pipe, a battery module, and an energy storage apparatus in each of which a plurality of holes is formed in a screen and a part of a pipe part is exposed through the plurality of holes.

### BACKGROUND

An energy storage system (ESS) is a system that improves energy usage efficiency by storing a large amount of electric energy and supplying the stored electric energy when the electric energy is required. The ESS may include a battery system, a battery management system (BMS) that manages the battery system, such as by monitoring a voltage, current, and temperature of the battery system, a power conversion system (PCS) that performs alternating current (AC)-direct current (DC) conversion and power distribution functions, and an energy management system (EMS) that integrates and controls the entire system of the ESS, such as by controlling an energy flow of the ESS and collecting and managing information on the state of the ESS.

The above information disclosed in this Background section is for enhancement of understanding of the background of the present disclosure, and therefore, the Background may contain information that does not constitute related (or prior) art.

### SUMMARY

Embodiments of the present disclosure are directed to providing a fire extinguishing pipe, a battery module, and an energy storage apparatus in each of which a plurality of holes is formed in a screen and a part of a pipe part is exposed through the plurality of holes.

However, the technical problem to be solved by the present disclosure is not limited to the above problem, and other problems not mentioned herein, and aspects and features of the present disclosure that would address such problems, will be clearly understood by those skilled in the art from the description of the present disclosure herein.

A fire extinguishing pipe according to embodiments of the present disclosure may include a fire extinguishing agent supply part configured to supply a fire extinguishing agent, a screen disposed between a plurality of battery cells and having a plurality of holes formed therein, and a pipe part connected to the fire extinguishing agent supply part and configured to have the fire extinguishing agent flow therethrough, the pipe part being configured to be partially exposed through the plurality of holes of the screen.

In embodiments, respective ones of the plurality of holes of the screen may be formed at locations corresponding to respective ones of the plurality of battery cells.

In embodiments, the plurality of holes of the screen may be formed so that each of the plurality of holes is disposed at the center of a short side part of the respective ones of the plurality of battery cells.

In embodiments, the screen may be made of a steel material.

In embodiments, the pipe part may be made of a material including one or more of polypropylene (PP), polyethylene (PE), and/or polyamide (PA).

In embodiments, the screen may have a pipe form.

In embodiments, the size of respective ones of the plurality of holes may be equal to or smaller than the diameter of the pipe part of the screen.

In embodiments, the screen may have a barrier form.

A battery module according to embodiments of the present disclosure may include a plurality of battery cells and a fire extinguishing pipe disposed between the plurality of battery cells. The fire extinguishing pipe may include a fire extinguishing agent supply part configured to supply a fire extinguishing agent, a screen disposed between the plurality of battery cells and having a plurality of holes formed therein, and a pipe part connected to the fire extinguishing agent supply part and configured to have the fire extinguishing agent flow therethrough, the pipe part being configured to be partially exposed through the plurality of holes of the screen.

In embodiments, respective ones of the plurality of holes of the screen may be formed at locations corresponding to respective ones of the plurality of battery cells.

In embodiments, the plurality of holes of the screen may be formed so that each of the plurality of holes is disposed at the center of a short side part of the respective ones of the plurality of battery cells.

In embodiments, the screen may be made of a steel material.

In embodiments, the pipe part may be made of a material including one or more of polypropylene (PP), polyethylene (PE), and/or polyamide (PA).

In embodiments, the screen may have a pipe form.

In embodiments, the size of respective ones of the plurality of holes may be equal to or smaller than the diameter of the pipe part of the screen.

In embodiments, the screen may have a barrier form.

In embodiments, the battery module may further include a side plate configured to fix a side of the plurality of battery cells and an end plate connected to the plurality of battery cells at both ends of the plurality of battery cells and coupled to the fire extinguishing agent supply part so that the fire extinguishing agent supply part is exposed to the outside.

In embodiments, the side plate may include an extension part extending beyond the end plate. The end plate may include a bent part bent in an outward direction thereof. The side plate and the end plate may be coupled by welding the extension part and the bent part.

In embodiments, the battery cell may be a prismatic secondary battery.

An energy storage apparatus according to embodiments of the present disclosure may include the battery module.

According to the embodiments of the present disclosure, only an exposed part of the pipe part is melted when an event occurs because the plurality of holes is formed in the screen and a part of the pipe part is exposed through the plurality of holes. Accordingly, an immediate fire extinguishing effect can be achieved by intensively spraying a fire extinguishing agent in the early stage of an event.

According to the embodiments of the present disclosure, a fire extinguishing effect can be improved by spraying a fire extinguishing agent onto an accurate location of a battery cell in which an event occurred within a rapid time because the plurality of holes is formed at locations of the pipe part, which correspond to the plurality of battery cells, respectively.

According to the embodiments of the present disclosure, the swelling of a battery cell can be prevented because the screen is constructed in a barrier form and coupled to the end plate.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIG. 1A is an upper perspective view of a prismatic secondary battery, according to some embodiments.

FIG. 1B is a cross-sectional view taken along line I-I of FIG. 1A, according to some embodiments.

FIG. 2 is a diagram illustrating a conventional battery module including a fire extinguishing pipe, according to some embodiments.

FIG. 3 is a diagram illustrating a form in which a fire extinguishing pipe according to some embodiments of the present disclosure has been applied.

FIG. 4 is a diagram illustrating a first embodiment of a fire extinguishing pipe according to some embodiments of the present disclosure.

FIG. 5 is a diagram illustrating a second embodiment of the fire extinguishing pipe according to some embodiments of the present disclosure.

FIG. 6 is a perspective view of a battery module according to some embodiments of the present disclosure.

FIG. 7 is a concept view illustrating an energy storage apparatus according to some embodiments of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own invention in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments. Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art. It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

Aspects of the technology will be described in detail with reference to the attached drawings.

A facility for suppressing a battery fire according to the occurrence of a fire attributable to an electric shock, a short circuit, or an external surge must be obligatorily installed in a space or facility in which the EMS is installed and operated. A common fire extinguishing system includes a fire sensing sensor and a spring cooler or a fire extinguishing agent sprayer that is installed around a battery rack or a ceiling.

Conventionally, there is a direct spray method of opening agent-side and module inlet-side valves and spraying an agent when an event, such as the opening of the vent of a battery cell, is detected. Such a direct spray method has a problem in that an immediate fire extinguishing effect cannot be expected until a module in which an event occurred is filled with an agent because the module is cooled by spraying the agent onto multiple cells of the module not an event cell.

In order to solve the disadvantage, there is presented a fire extinguishing method of a fire extinguishing pipe being melted by radiation heat of an event cell within a module when an event occurs, detecting smoke that is generated simultaneously with the event, opening an agent-side valve, and inputting an agent. The fire extinguishing method may improve the reliability of fire extinguishment because the agent reaches a cell around the event, but has a problem in that an effect of the agent is not rapidly achieved, such as that an event cell is not directly cooled, because the agent-side valve is opened up to an unwanted range.

Examples of secondary batteries include a coin type, a cylindrical type, a prismatic type, and a pouch type. The present disclosure is applicable to a prismatic secondary battery. Therefore, the prismatic secondary battery will first be briefly described prior to description of embodiments of the present disclosure.

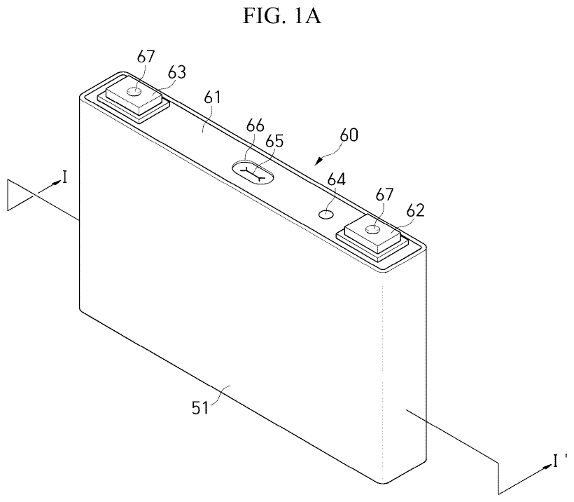

FIG. 1A is a top perspective view of the prismatic secondary battery, according to some embodiments. FIG. 1B is a cross-sectional view taken along line I-I′ of FIG. 1A, according to some embodiments.

First, the external appearance of the prismatic secondary battery illustrated in FIG. 1A will be described.

A casing 51 defines an overall appearance of the prismatic secondary battery, and may be made of conductive metal, such as aluminum, aluminum alloy, or nickel-plated steel. In addition, the casing 51 may provide a space for accommodating an electrode assembly therein.

A cap assembly 60 may include a cap plate 61 that covers the opening of the casing 51, and the cap assembly 60 and the cap plate 61 may be made of a conductive material. Here, a first terminal 63 and a second terminal 62 may be electrically connected to respective positive and negative (or negative and positive) electrodes inside the casing, and may be installed to protrude outward through the cap plate 61.

The cap plate 61 may be equipped with an electrolyte injection port 64 formed to install a sealing plug, and a vent 66 formed with a notch 65. The vent 66 is for degassing the secondary battery, i.e., for discharging gas generated inside the secondary battery.

With reference to FIG. 1B, the internal structure of the prismatic secondary battery and the coupling structure with the cap assembly 60 will be described.

As illustrated in FIG. 1B, the prismatic secondary battery may include an electrode assembly 40, a first current collector part 41, a first terminal 62, a second current collector part 42, a second terminal 63, and a cap assembly 60.

The electrode assembly 40 may be formed by winding or stacking a laminate of a first electrode plate, a separator, and a second electrode plate, which are in the form of a plate or a film. When the electrode assembly 40 is a wound laminate, it may have a winding axis parallel to the longitudinal direction of the casing. The electrode assembly 40 may be of a stack type rather than a winding type, but the shape of the electrode assembly 40 is not limited in the present disclosure. In addition, the electrode assembly 40 may be a Z-stack electrode assembly in which a first electrode plate and a second electrode plate are inserted into both sides of a separator bent into a Z-stack.

Furthermore, the electrode assembly 40 may consist of one or more electrode assemblies, which are stacked such that their long sides are adjacent to each other and accommodated in the casing, and the number of electrode assemblies is not limited in the present disclosure. The electrode assembly 40 may have a first electrode plate that acts as a negative electrode and a second electrode plate that acts as a positive electrode, or vice versa.

The first electrode plate may be formed by applying a first electrode active material, such as graphite or carbon, to a first electrode current collector plate made of metal foil, such as copper, copper alloy, nickel, or nickel alloy. The first electrode plate may include a first electrode tab (or first uncoated part) 43, which is a region without application of the first electrode active material. The first electrode tab 43 may act as a current flow passage between the first electrode plate and the first current collector part 41. In some examples, the first electrode tab 43 may be formed by cutting the first electrode plate to protrude to one side in advance when manufacturing the first electrode plate, and may protrude further to one side than the separator without separate cutting.

The second electrode plate may be formed by applying a second electrode active material such as transition metal oxide to a substrate made of metal foil, such as aluminum or aluminum alloy. The second electrode plate may include a second electrode tab (or second uncoated part) 44, which is a region without application of the second electrode active material.

The second electrode tab 44 may act as a current flow passage between the second electrode plate and the second current collector part 42. In some examples, the second electrode tab 44 may be formed by cutting the second electrode plate to protrude to the other side in advance when manufacturing the second electrode plate, and may protrude further to the other side than the separator without separate cutting.

In some embodiments, the first electrode tab 43 may be located on the right end side of the electrode assembly 40, and the second electrode tab 44 may be located on the left end side of the electrode assembly 40. Alternatively, the first electrode tab 43 and the second electrode tab 44 may be located on one end side of the electrode assembly 40 in the same direction. Here, the left and the right are represented based on the secondary battery illustrated in FIG. 1 for convenience of explanation, and they may change in position when the secondary battery is rotated left and right or up and down.

The separator functions to prevent a short circuit between the first electrode plate and the second electrode plate while permitting migration of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate extend from both ends of the electrode assembly 40 as described above, respectively. In some embodiments, the electrode assembly 40 may be accommodated together with an electrolyte in the casing 51.

In the electrode assembly 40, the first current collector part 41 and the second current collector part 42 may be welded and connected to the first electrode tab 43 extending from the first electrode plate and the second electrode tab 44 extending from the second electrode plate, respectively.

The first current collector part 41 and the second current collector part 42 are connected to the first terminal 62 and the second terminal 63, as described with reference to FIG. 1A, through terminal pins 67, respectively. In some embodiments, the terminal pins 67 may each have an outer peripheral surface that is threaded, and may be fastened to the first terminal 62 and the second terminal 63, for example, by screwing with one or more screws. However, the present disclosure is not limited thereto. For example, the terminal pins 67 may also be coupled to the first terminal 62 and the second terminal 63 by riveting or welding.

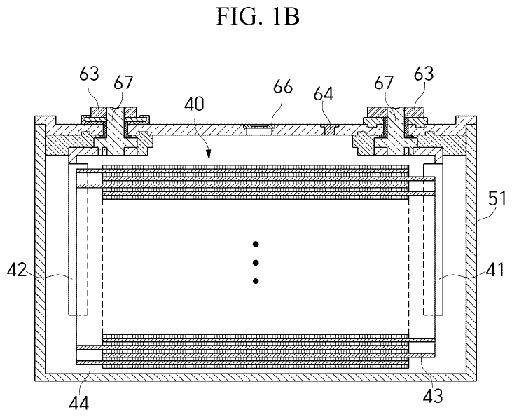

FIG. 2 is a diagram illustrating a conventional battery module including a fire extinguishing pipe, according to some embodiments.

Referring to FIG. 2, in the conventional battery module including the fire extinguishing pipe, the fire extinguishing pipe may include a fire extinguishing agent supply part 11 and a pipe part 12, and may be disposed between a plurality of battery cells 1. In some embodiments, the fire extinguishing pipe may be disposed between column Nos. 1 and 2 of the battery cells.

The fire extinguishing agent supply part 11 may be connected to a fire extinguishing agent accommodation part (not illustrated) in which a fire extinguishing agent is accommodated, and may be supplied with the fire extinguishing agent. In embodiments, the fire extinguishing agent supply part 11 may be an inlet that is exposed by protruding to one side of the battery module. The fire extinguishing agent that is supplied through the fire extinguishing agent supply part 11 may extinguish a fire by being sprayed and consumed when an event occurs in some of the battery cells included in the battery module.

The pipe part 12 may be made of polymer-based thermoplastic resin, such as polyamide (PA), and may not be influenced by corrosion for a long period of time. The pipe part 12 may be easily melted by radiation heat of the battery cell 1 in which an event occurs.

When an event occurs in the battery cell 1, a temperature the battery cell suddenly rises. The temperature at this time is about 1000° C. or more in NCA (national compressed air) series and about 400° C. or more in LFP (lithium iron phosphate) series. The fire extinguishing agent may be input to a hole in an unspecified area that is generated because the pipe part 12 is melted due to radiation heat on the side of the battery cell 1, which occurs at this time, and may cool the battery cell 1 within the housing of the battery module by dipping the battery cell 1 into the fire extinguishing agent.

However, in such a conventional structure, the pipe part 12 may be lost or broken to the range or more of the side of the battery cell 1, or a hole is generated in an irregular range. When the pipe part 12 is broken as described above, the fire extinguishing agent may be spurted due to spray pressure of the fire extinguishing agent in the direction of the conduit (i.e., to the back of the battery module) not the direction of the battery cell 1 when an event occurs.

Accordingly, the conventional structure has a problem in that it is difficult to achieve a direct cooling effect in addition to immersion because although a hole is generated in a wide range, the fire extinguishing agent does not generate proper spray pressure and does not directly cool the battery cell 1.

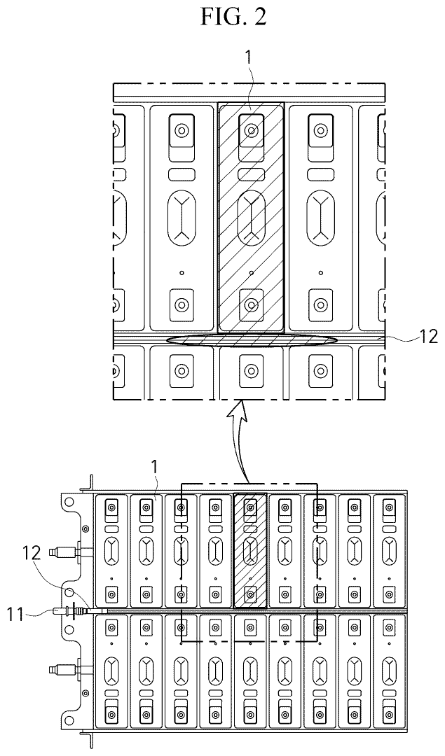

FIG. 3 is a diagram illustrating a form in which a fire extinguishing pipe according to some embodiments of the present disclosure has been applied.

Referring to FIG. 3, the fire extinguishing pipe according to some embodiments of the present disclosure may include a fire extinguishing agent supply part 110, a screen 120, and a pipe part 130.

The fire extinguishing agent supply part 110 may be connected to a fire extinguishing agent accommodation part (not illustrated) in which a fire extinguishing agent is accommodated, and may be supplied with the fire extinguishing agent. In embodiments, the fire extinguishing agent supply part 110 may be an inlet that is exposed by protruding to one side of a battery module. The fire extinguishing agent that is supplied through the fire extinguishing agent supply part 110 may extinguish a fire by being sprayed and consumed when an event occurs in some of the battery cells included in the battery module.

The fire extinguishing agent accommodation part may include an agent container in which the fire extinguishing agent is stored, and may allow the fire extinguishing agent to be supplied through the fire extinguishing agent supply part 110 via a separate valve when the separate valve is opened.

The agent container may be fixed to an installation place by a package method or a wall part fixing method. As an example, the agent container may be a pressure container in which a high-pressure fire extinguishing agent is stored. Internal pressure of the agent container may be different depending on a country to which a fire extinguishing system is applied or the type of fire extinguishing agent.

Furthermore, all of the fire extinguishing agents that are commonly used, such as gas-based fire extinguishing agents, such as trifluoromentane (HFC-23, CHF₃)/pentafluoroethane (HFC-125, C₂HF₅)/heptafluoropropane (HFC227ea, CF₃CHFCF₃), dodecapluoro-2-methyl pentane-3-one (CF₃CF₂C(O)CF(CF₃)₂), and water, may be applied to the fire extinguishing agent that is stored in the agent container. The fire extinguishing agent may be stored in the agent container by a method, such as an accumulator type or a pressurized type method.

The screen 120 may be disposed between a plurality of battery cells 1. A plurality of holes may be formed in the screen 120. The pipe part 130 may be connected to the fire extinguishing agent supply part 110. The fire extinguishing agent may flow into the pipe part 130. A part of the pipe part 130 may be exposed through the plurality of holes. An accommodation part in which the pipe part 130 is accommodated may be formed in the screen 120. The plurality of holes may be formed in a part of the screen 120, which includes the accommodation part. In embodiments, the screen 120 may be made of a steel material. The pipe part 130 may be a material including one or more of polypropylene (PP), polyethylene (PE), and polyamide (PA). When an event occurs, the screen 120 may maintain its shape because the melting point of steel is 1500° C. or more, and only the pipe part 130 exposed through the hole may be lost due to radiation heat and thus the fire extinguishing agent may be sprayed through the hole. Accordingly, spray pressure and spray location of the fire extinguishing agent may be controlled by adjusting the size and location of the hole of the screen 120.

In some embodiments, the plurality of holes of the screen 120 may be formed at locations corresponding to the plurality of battery cells 1, respectively. Accordingly, direct fire extinguishing can be performed on the battery cell 1 in which an event occurs because only the pipe part 130, which is exposed to a hole formed in a part of the screen 120 corresponding to the battery cell 1 in which the event occurs, is melted and the fire extinguishing agent is sprayed through the exposed part of the pipe part 130. As illustrated in FIG. 3, the plurality of holes of the screen 120 may be formed so that each of the plurality of holes is disposed at the center of a short-side part of each of the plurality of battery cells 1. Accordingly, more effective fire extinguishing can be performed because the fire extinguishing agent is sprayed at an accurate location.

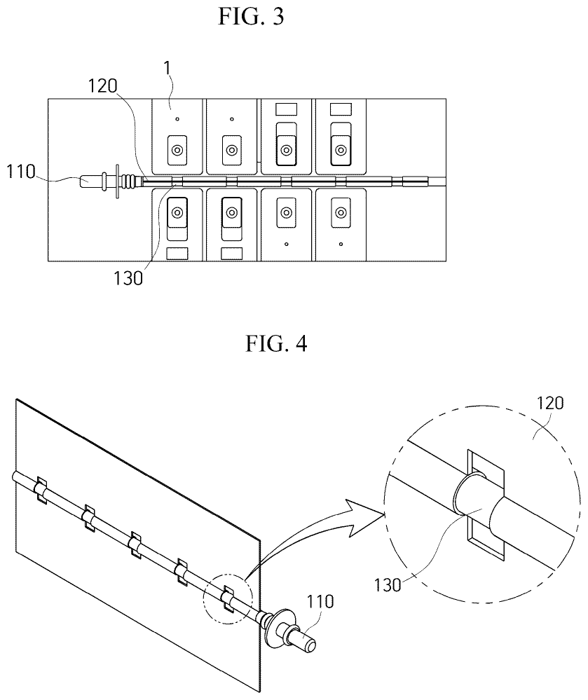

FIG. 4 is a diagram illustrating a first embodiment of the fire extinguishing pipe according to some embodiments of the present disclosure.

Referring to FIG. 4, the screen 120 of the fire extinguishing pipe according to some embodiments of the present disclosure may have a pipe form. In this case, the thickness of the screen 120 may be 0.5 mm or more so that radiation heat can be sufficiently blocked. Furthermore, the diameter of the pipe part 130 may be 8 mm, and the thickness of the pipe part 130 may be 1 mm or more by considering a thermal runaway temperature and melting point.

In some embodiments, the hole that is formed in the screen 120 may be a circular hole. In embodiments, the size of the hole may be equal to or smaller than the diameter of the pipe of the screen 120. If the size of the hole is greater than the diameter of the pipe of the screen 120, when an event occurs and thus the pipe part 130 corresponding to the hole is lost, the fire extinguishing agent cannot be properly sprayed because spray pressure of the fire extinguishing agent, which is generated through the hole, is smaller than fluid pressure of the fire extinguishing agent that flows into the pipe part 130. The fire extinguishing agent can be strongly sprayed onto a battery cell in which an event occurs because spray pressure of the fire extinguishing agent, which is generated through the hole, is greater than fluid pressure of the fire extinguishing agent that flows into the pipe part 130 only when the size of the hole is equal to or smaller than the diameter or more of the pipe of the screen 120.

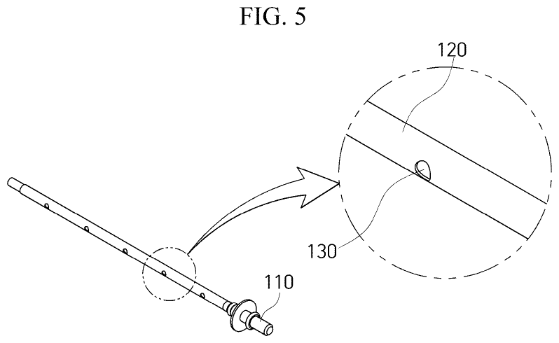

FIG. 5 is a diagram illustrating a second embodiment of the fire extinguishing pipe according to some embodiments of the present disclosure.

Referring to FIG. 5, the screen 120 of the fire extinguishing pipe according to some embodiments of the present disclosure may have a barrier form. In this case, the thickness of the screen 120 may be 0.5 mm or more so that radiation heat can be sufficiently blocked. Furthermore, the diameter of the pipe part 130 may be 8 mm, and the thickness of the pipe part 130 may be 1 mm or more by considering a thermal runaway temperature and melting point.

In some embodiments, the hole that is formed in the screen 120 may be a quadrangular hole. If the screen 120 has a barrier form, there is an advantage in that it is advantageous to prevent the propagation of heat because the screen 120 can block radiation heat between column Nos. 1 and 2 of the battery cell 1. Furthermore, if the screen 120 has a barrier form, the screen 120 may be used as a structure that prevents the swelling of the battery cell 1 when the screen 120 is coupled with the end plate of the housing of the battery module.

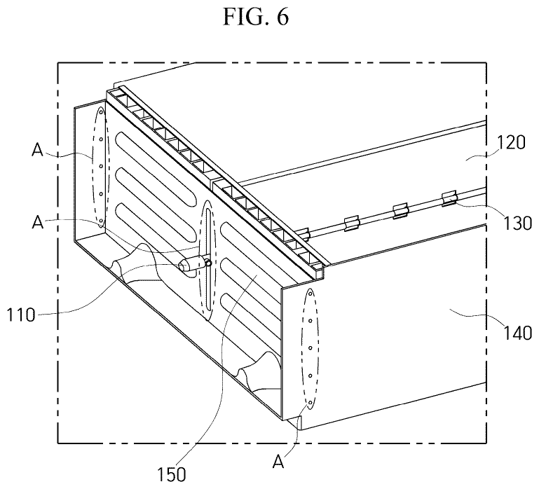

FIG. 6 is a perspective view of a battery module according to some embodiments of the present disclosure.

Referring to FIG. 6, the battery module according to some embodiments of the present disclosure may include a side plate 140 that fixes the side of the plurality of battery cells 1 along with the fire extinguishing pipe, and an end plate 150 that is connected to the battery cells 1 at both ends of the plurality of battery cells 1 and that is coupled with the fire extinguishing agent supply part 110 so that the fire extinguishing agent supply part 110 is exposed to the outside.

In some embodiments, the side plate 140 may include an extension part that extends beyond the end plate 150. The end plate 150 may include a bent part that is bent in an outward direction thereof. The side plate 140 and the end plate 150 may be coupled by welding the extension part and the bent part. As illustrated in FIG. 6, the battery module according to embodiments of the present disclosure may include three welding parts A, including two welding parts between the side plate 140 and the end plate 150 and one welding part between the fire extinguishing pipe and the end plate 150. Accordingly, the swelling of the battery cell 1 can be prevented because the end plate 150 is firmly coupled to the side plate 140 and the fire extinguishing pipe and provides a counterforce against the swelling direction of the battery cell 1.

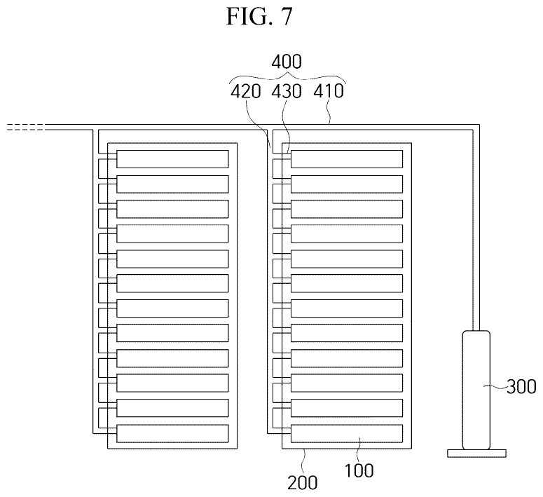

FIG. 7 is a concept view illustrating an energy storage apparatus according to some embodiments of the present disclosure.

Referring to FIG. 7, the energy storage apparatus according to some embodiments of the present disclosure includes a plurality of battery racks 200 including a plurality of battery modules 100. In each of the battery racks 200, the battery modules 100 may be stacked in one direction, for example, a vertical direction. Such battery modules 100 may perform a desired output by being connected in series, in parallel, or in a series-parallel way.

A fire extinguishing agent accommodation part 300 may accommodate a fire extinguishing agent. A supply pipe 400 may be connected to the fire extinguishing agent accommodation part 300, and may supply the fire extinguishing agent.

The supply pipe 400 may connect the fire extinguishing agent accommodation part 300 and the battery modules 100 within the battery rack 200. To this end, the supply pipe 400 may include a main pipe part 410 that is connected to the fire extinguishing agent accommodation part 300, a branch pipe part 420 that is branched from the main pipe part 410 to each battery rack 200, and a module pipe part 430 that connects the branch pipe part 420 and each of the battery modules 100 included in the battery rack 200.

The main pipe part 410 may be formed to have one end connected to the fire extinguishing agent accommodation part 300, to extend from the fire extinguishing agent accommodation part 300, and to pass by one side of all of the battery racks 200 within an EMS or nearby thereof. Accordingly, when the valve of the fire extinguishing agent accommodation part 300 is opened, the fire extinguishing agent can be transferred to the vicinity of the battery rack 200 where the fire extinguishing agent needs to be supplied.

The branch pipe part 420 may be branched off from the main pipe part 410. In particular, the branch pipe part 420 may be extended and formed in a direction in which the battery modules 100 are stacked within a corresponding battery rack 200. The branch pipe part 420 may provide a path along which the fire extinguishing agent that moves near the battery rack 200 along the main pipe part 410 is transferred to the battery module 100 within the battery rack 200.

The module pipe part 430 may connect the branch pipe part 420 and each of the battery modules 100. The module pipe part 430 may allow the fire extinguishing agent of the branch pipe part 420 to be supplied a fire extinguishing pipe formed in the battery module 100. In some embodiments, the module pipe part 430 may be the fire extinguishing agent supply part 110 of the fire extinguishing pipe according to some embodiments of the present disclosure.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination thereof, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination thereof.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤a≤2); LiₐNi_{1-b-c}Mn_{b}X_{c}O_{2-α}D_{α} (0.90≤a≤1.8, 0≤b≤0.5, 0≤c≤0.5, 0≤a≤2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination thereof. X may be Al, Ni, Co, Mn, Cr, Fe, Mg, Sr, V, a rare earth element, or a combination thereof; D may be O, F, S, P, or a combination thereof. G may be Al, Cr, Mn, Fe, Mg, La, Ce, Sr, V, or a combination thereof. L¹ may be Mn, Al, or a combination thereof.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure is not limited thereto.

A negative electrode active material may include a material capable of reversible intercalation/de-intercalation with respect to lithium ions, lithium metal, an alloy of lithium metal, a material capable of doping and dedoping with respect to lithium, or transition metal oxide.

The material capable of reversible intercalation/de-intercalation with respect to lithium ions may include a carbon-based negative electrode active material, for example, crystalline carbon, amorphous carbon, or a combination thereof. An example of the crystalline carbon may include graphite, such as natural graphite or synthetic graphite.

Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination thereof may be used as the binder.

If the aqueous-based binder is used as a binder for the negative electrode, the binder for the negative electrode may further include a cellulose-series compound capable of assigning viscosity.

One material selected among nickel foil, stainless steel foil, titanium foil, nickel foam, copper foam, a polymer base on which a conductive metal has been coated, and a combination thereof may be used for the negative electrode. An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination thereof. The carbonate-based, ester-based, ether-based, ketone-based, or alcohol-based solvent, or the aprotic solvent may be used solely, or two types or more thereof may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers thereof may be used as the separator.

The separator may include a porous base, and a coating layer including an organic matter, an inorganic matter, or a combination thereof that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described above in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A fire extinguishing pipe comprising:
a fire extinguishing agent supply part configured to supply a fire extinguishing agent;
a screen disposed between a plurality of battery cells and having a plurality of holes formed therein; and
a pipe part connected to the fire extinguishing agent supply part and configured to have the fire extinguishing agent flow therethrough, the pipe part being configured to be partially exposed through the plurality of holes of the screen.

2. The fire extinguishing pipe as claimed in claim 1, wherein respective ones of the plurality of holes of the screen are formed at locations corresponding to respective ones of the plurality of battery cells.

3. The fire extinguishing pipe as claimed in claim 2, wherein the plurality of holes of the screen is formed so that each of the plurality of holes is disposed at a center of a short side part of the respective ones of the plurality of battery cells.

4. The fire extinguishing pipe as claimed in claim 1, wherein the screen is made of a steel material.

5. The fire extinguishing pipe as claimed in claim 1, wherein the pipe part is made of a material comprising one or more of polypropylene (PP), polyethylene (PE), and/or polyamide (PA).

6. The fire extinguishing pipe as claimed in claim 1, wherein the screen has a pipe form.

7. The fire extinguishing pipe as claimed in claim 6, wherein a size of respective ones of the plurality of holes is equal to or smaller than a diameter of the pipe part of the screen.

8. The fire extinguishing pipe as claimed in claim 1, wherein the screen has a barrier form.

9. A battery module comprising:
a plurality of battery cells; and
a fire extinguishing pipe disposed between the plurality of battery cells,
wherein the fire extinguishing pipe comprises:
a fire extinguishing agent supply part configured to supply a fire extinguishing agent;
a screen disposed between the plurality of battery cells and having a plurality of holes formed therein; and
a pipe part connected to the fire extinguishing agent supply part and configured to have the fire extinguishing agent flow therethrough, the pipe part being configured to be partially exposed through the plurality of holes of the screen.

10. The battery module as claimed in claim 9, wherein respective ones of the plurality of holes of the screen are formed at locations corresponding to respective ones of the plurality of battery cells.

11. The battery module as claimed in claim 10, wherein the plurality of holes of the screen is formed so that each of the plurality of holes is disposed at a center of a short side part of the respective ones of the plurality of battery cells.

12. The battery module as claimed in claim 9, wherein the screen is made of a steel material.

13. The battery module as claimed in claim 9, wherein the pipe part is made of a material comprising one or more of polypropylene (PP), polyethylene (PE), and/or polyamide (PA).

14. The battery module as claimed in claim 9, wherein the screen has a pipe form.

15. The battery module as claimed in claim 14, wherein a size of respective ones of the plurality of holes is equal to or smaller than a diameter of the pipe part of the screen.

16. The battery module as claimed in claim 9, wherein the screen has a barrier form.

17. The battery module as claimed in claim 9, further comprising:
a side plate configured to fix a side of the plurality of battery cells; and
an end plate connected to the plurality of battery cells at both ends of the plurality of battery cells and coupled to the fire extinguishing agent supply part so that the fire extinguishing agent supply part is exposed to an outside.

18. The battery module as claimed in claim 17, wherein:
the side plate comprises an extension part extending beyond the end plate,
the end plate comprises a bent part bent in an outward direction thereof, and
the side plate and the end plate are coupled by welding the extension part and the bent part.

19. The battery module as claimed in claim 9, wherein the battery cell is a prismatic secondary battery.

20. An energy storage apparatus comprising the battery module as claimed in claim 9.
